(19) United States
(12) Patent Application Publication
(10) Pub. No.: US 2004/0218058 A1
(43) Pub. Date: Nov. 4, 2004

(54) System for providing synthesized images, apparatus and program for synthesizing images

(76) Inventors: Hiroshi Yamaguchi, Kanagawa-ken (JP); Jun Enomoto, Kanagawa-ken (JP); Mamoru Shinohara, Kanagawa-ken (JP); Yoichi Nakamura, Kanagawa-ken (JP)

Correspondence Address: BIRCH STEWART KOLASCH & BIRCH, PO BOX 747, FALLS CHURCH, VA, 22040-0747, US

(21) Appl. No.: 10/807,381

(22) Filed: Mar. 24, 2004

(30) Foreign Application Priority Data
Mar. 25, 2003 (JP) (PAT)082888/2003

(51) Int. Cl. H04N 5/335

(52) U.S. Cl. 348/218.1

(57) ABSTRACT

Provision of synthesized images, in which images that have been photographed at a plurality of locations are favorably laid out according to the photography locations thereof, is enabled. Subjects who hold wireless tags, in which subject specifying data is recorded, are photographed by a plurality of photography units, which are provided at predetermined locations. At the time of photography, the subject specifying data is obtained from the wireless tags. The photographed images and the subject specifying data are transmitted together to a server, where they are stored. The server searches for image data sets from among image data sets stored therein, in which a predetermined subject is pictured, based on the subject specifying data. The server also searches for predetermined template data sets, based on the photography locations of the located image data sets. Synthesized images are generated by synthesizing the image data sets in predetermined layouts.

### BACKGROUND OF THE INVENTION

1. Field of the Invention

The present invention relates to a system for providing synthesized images wherein images obtained by photographing subjects are synthesized with templates or the like, which is suitable for use in tourist spots, such as amusement parks and theme parks. The present invention also relates to an apparatus and program for synthesizing images.

2. Description of the Related Art

Photography services are provided at tourist spots, such as amusement parks and theme parks. As an example of such a photography service, there are those wherein visitors are photographed within attractions, then prints of the photographed images are offered for sale at the end of the attraction.

A system for providing images that improves the efficiency of a service such as that described above is disclosed in U.S. Pat. No. 6,628,899.

As an example of the system for providing images, one such as that described below is being considered.

First, communication devices, in which ID data (subject specifying data) of users are recorded, are distributed among the users. Thereafter, every time that a user who is holding a communication device approaches an attraction or a predetermined photography spot within the tourist spot, a camera provided at that location automatically photographs the user. At the same time, ID data is obtained from the communication device held by the photographed user. The image data sets obtained by photography and the ID data of the user are correlated and transmitted to a server, where the image data sets and the ID data are stored.

When an order is received from an order terminal provided within the tourist spot, the server searches for image data sets in which the user is pictured, based on the ID data. The image data sets located by the search are printed, then provided to the user. Alternatively, the image data sets are recorded on recording media or the like, and provided to the user.

Thereby, users are enabled to order groups of desired images, from among a plurality of images photographed within the tourist spot, by utilizing the order terminal when it is convenient for them to do so. Therefore, it is possible to provide a more convenient service.

A possible service, to which a system for providing images may be applied, is a “photo rally” service. In the “photo rally” service, users are caused to visit a plurality of predetermined attractions, such as three large roller coasters within an amusement park. A plurality of images, each photographed at each attraction, may be provided as a single image, by being synthesized with a template or the like.

Consider a case that the three large roller coasters within an amusement park are designated as the predetermined attractions. In this case, images may be laid out in different templates, depending on whether a user rode all three, two out of three, or one of the roller coasters. Thereby, synthesized images corresponding to each user may be provided.

Alternatively, synthesized images, in which images are synthesized with templates that represent a map of an amusement park at positions corresponding to the photography locations, may be provided.

That is, synthesized images are provided, in which images of users are synthesized with predetermined templates, corresponding to the locations at which the users were photographed. Thereby, a more attractive service may be provided, compared to the conventional service, in which photographed images were simply printed out.

However, U.S. Pat. No. 6,628,899 does not disclose a system capable of providing such a service.

### SUMMARY OF THE INVENTION

The present invention has been developed in view of the circumstances described above. It is an object of the present invention to provide a system for synthesizing images, capable of providing synthesized images wherein images, which are photographed at a plurality of locations, are laid out in a preferable manner, corresponding to the photography locations.

The system for providing synthesized images according to the present invention comprises:

a plurality of cameras for photographing subjects and obtaining image data sets, provided at predetermined locations;

a transmitting means for transmitting the image data sets, provided at each of the plurality of cameras;

an image managing means for storing the image data sets, which have been transmitted by the transmitting means;

a subject specifying means, for specifying the subjects which are pictured in the image data sets;

a template managing means for storing template data sets, which are to be synthesized with the image data sets;

an image searching means for searching among the image data sets, which are stored in the image managing means, for image data sets, in which the subjects specified by the subject specifying means are pictured;

an image synthesizing means for generating synthesized image data sets, by synthesizing image data sets, which have been located by the image searching means, with predetermined template data sets from among the template data sets, which are stored in the template managing means, according to the photography location of the image data sets, in a predetermined layout; and

an output means, for outputting the synthesized image data sets.

Here, the “template data sets” are not strictly limited to templates. The “template data sets” also include image data sets of characters and text data, to be synthesized along with the template data sets.

Examples of the “output means” include printers for printing the synthesized image data sets on paper, recording devices for recording the image data sets onto recording media, and communication devices for distributing the image data sets on the Internet.

A configuration may be adopted wherein the subject specifying means comprises:

subject specifying data transmitting means for transmitting prerecorded subject specifying data; and

subject specifying data receiving means for receiving the subject specifying data, transmitted from the subject specifying data transmitting means; wherein:

the subject specifying data transmitting means are distributed among subjects in advance; and

the subject specifying data receiving means receives the subject specifying data of a photographed subject from the subject specifying data transmitting means held by the photographed subject, corresponding to photography operations of the cameras.

A long distance wireless communication tag (an RFID tag, Radio Frequency Identification, having a communicable range of several meters) may be utilized as the subject specifying data transmitting means and the subject specifying data receiving means.

Alternatively, a configuration may be adopted wherein the subject specifying means comprises:

media, in which subject specifying data are recorded; and

readout means for reading out the subject specifying data from the media; wherein:

the media are distributed among subjects in advance; and

the readout means reads out the subject specifying data of a photographed subject from the medium held by the photographed subject, corresponding to photography operations of the cameras.

Bar codes or magnetic stripes, and correspondent readout devices therefor, may be utilized as the media and the readout means in this case.

The system for providing synthesized images according to the present invention may further comprise:

an image selecting means for selecting image data sets from among the image data sets, which have been located by the image searching means, to be synthesized with the template data sets.

The synthesizing means may further comprise:

a template selecting means for selecting template data sets from among the template data sets, which are stored in the template managing means, to be synthesized with the image data sets; wherein:

the selected template data sets are synthesized with the image data sets.

It is preferable that the template selecting means increases the number of selectable template data sets, with which the image data sets are synthesized, according to the number of image data sets in which the same subject is pictured.

The image synthesizing apparatus according to the present invention comprises:

an image receiving means for receiving input of image data sets; and

an image synthesizing means; wherein the image synthesizing means generates synthesized image data sets, by synthesizing image data sets, which have been input, with predetermined template data sets according to the photography location of the image data sets, in a predetermined layout.

The image synthesizing program according to the present invention comprises the procedures of:

receiving input of image data sets; and

generating synthesized images; wherein synthesized images are generated, by synthesized image data sets, which have been input, with predetermined template data sets according to the photography location of the image data sets, in a predetermined layout.

The image synthesizing program according to the present invention may be provided recorded on a computer readable medium. Those skilled in the art would know that computer readable media are not limited to any particular type of device. The computer readable media may be any type of device, including but not limited to: floppy disks, CD's, RAM's, ROM's, magnetic tapes, and internet downloads, in which computer instructions/code may be transmitted.

The system for providing synthesized images according to the present invention performs photography of subjects with a plurality of cameras, which are provided at a plurality of locations. The image data sets obtained by photography are transmitted to the image managing means by the transmitting means, and stored at the image managing means. Thereafter, image data sets, in which specific subjects are pictured, are searched for from among the image data sets stored in the image managing means. Then, the image synthesizing means obtains template data sets corresponding to the photography locations of the located image data sets, from the template managing means. The image data sets and the template data sets are synthesized in predetermined layouts, and synthesized image data sets are output by the output means. Thereby, synthesized images are provided, in which images of users are synthesized with predetermined templates, corresponding to the locations at which the users were photographed. Accordingly, a more attractive service may be provided, compared to conventional image printing services.

### BRIEF DESCRIPTION OF THE DRAWINGS

FIG. 1 is a schematic block diagram illustrating the construction of the system for providing synthesized images according to the first embodiment of the present invention.

FIG. 2 is a drawing for explaining a subject specifying data database.

FIG. 3 illustrates an installment example of a photography unit of the system for providing synthesized images according to the first embodiment of the present invention.

FIG. 4 is a schematic block diagram illustrating the construction of a server.

FIG. 5 is a schematic block diagram illustrating the construction of an order terminal.

FIG. 6 is a drawing for explaining a photography data database.

FIG. 7 is a flowchart that illustrates the processes of image ordering and image synthesis in the system for providing synthesized images according to the first embodiment of the present invention.

FIG. 8 is a drawing for explaining the photography data extracted from the photography data database.

FIG. 9 illustrates an example of a synthesized image.

FIG. 10 is a schematic block diagram illustrating the construction of a system for providing synthesized images according to a second embodiment of the present invention.

FIG. 11 illustrates an installment example of a photography unit of the system for providing synthesized images according to the second embodiment of the present invention.

### DESCRIPTION OF THE PREFERRED EMBODIMENTS

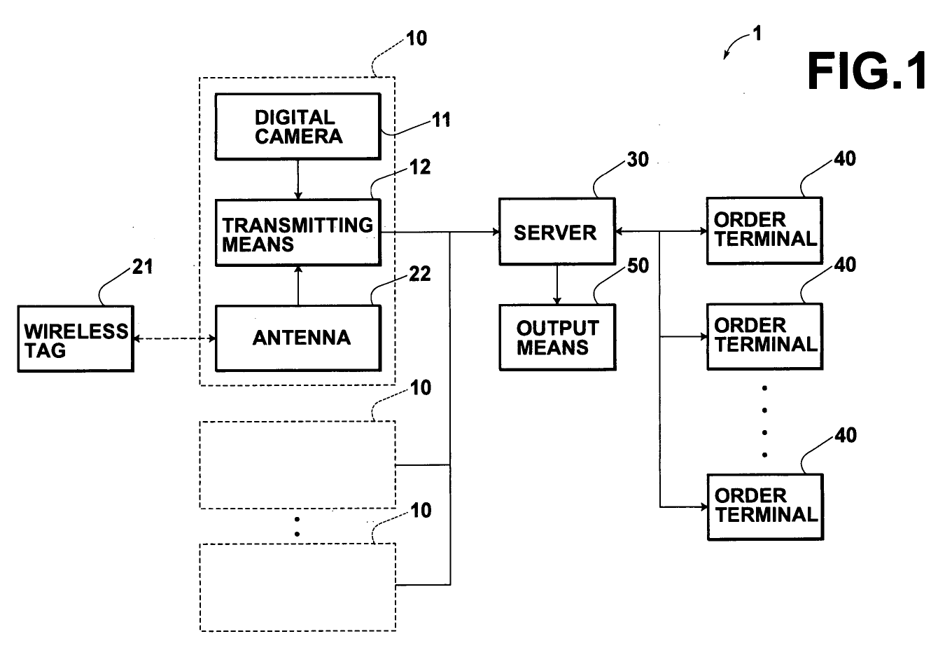

Hereinafter, preferred embodiments of the present invention will be described with reference to the attached drawings. FIG. 1 is a block diagram illustrating the construction of a system for providing synthesized images 1 according to the first embodiment.

The system for providing synthesized images 1 comprises: a plurality of photography units 10; a plurality of wireless tags 21; a server 30; order terminals 40; and an output means 50. The photography units 10 perform automatic photography of subjects (users of the service). The wireless tags 21 are held by the subjects, and transmit subject specifying data that specifies the subjects. The server 30 stores image data sets obtained by the photography units 10, and generates synthesized images based on these image data sets. The order terminals 40 access the server 30 to order synthesized images. The output means 50 output the synthesized images, which are generated by the server 30.

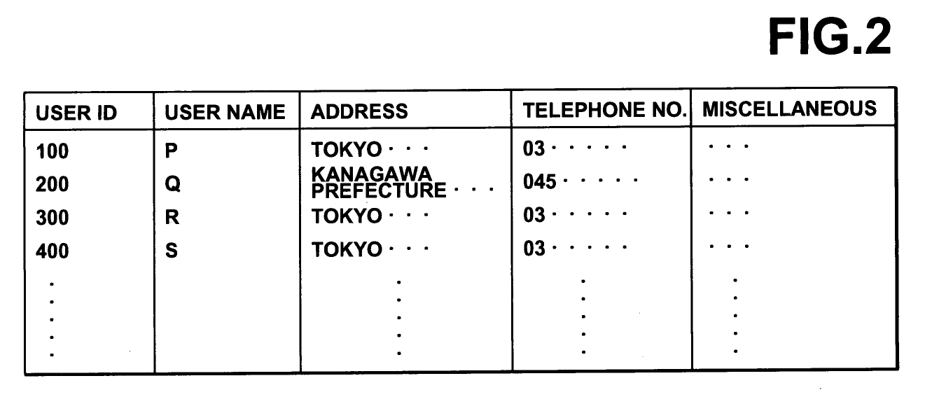

As specific examples of the wireless tags 21, RFID tags, which have built in batteries and have communicable ranges of several meters or more, may be considered. The wireless tags 21 are distributed among users of the service provided by the system for providing synthesized images 1. In addition, each of the wireless tags 21 have individual user ID's recorded therein. At the time that the wireless tags 21 are distributed, user information necessary for the service, such as the user's name, the user's address, and the user's telephone number are obtained. Then, the user information is correlated with the user ID's and recorded in a subject specifying data database, such as that shown in FIG. 2, within the server 30. Thereby, the wireless tags 21 need only transmit the user ID as the subject specifying data. Accordingly, communications are simplified.

Each of the photography units 10 comprises: a digital camera 11; an antenna 22; and a transmitting means 12. The digital camera 11 photographs the subjects. The antenna 22 receives the subject specifying data from the wireless tags 21. The transmitting means 12 transmits the image data sets obtained by the digital camera 11 and the subject specifying data received by the antenna 22 to the server 30.

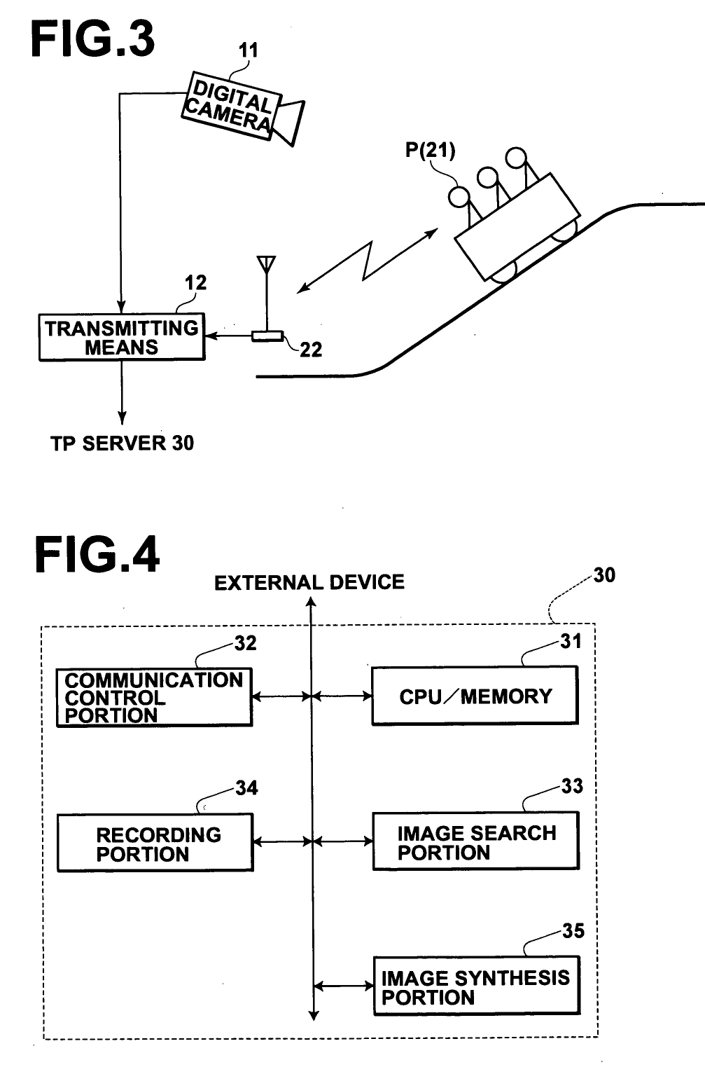

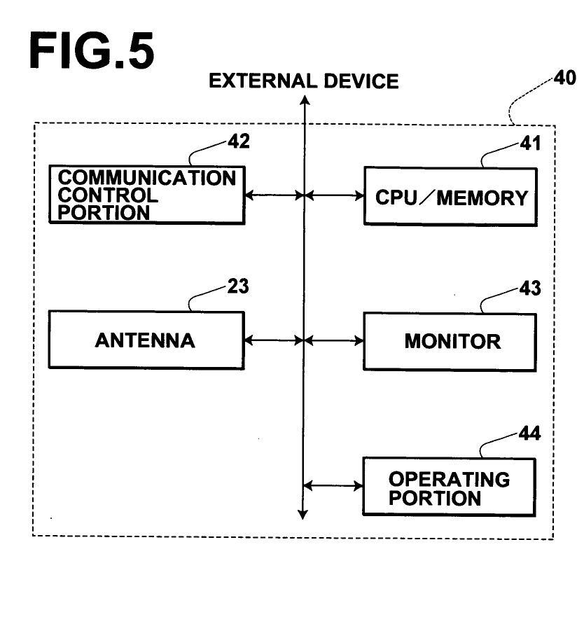

FIG. 3 illustrates an example, in which the photography unit 10 is provided at an attraction (a roller coaster) within a theme park. The digital camera 11 is provided at a position so that it is capable of performing photography when the roller coaster arrives at a predetermined photography spot. The antenna 22 is provided within a communicable range of the wireless tags 21 from the photography spot.

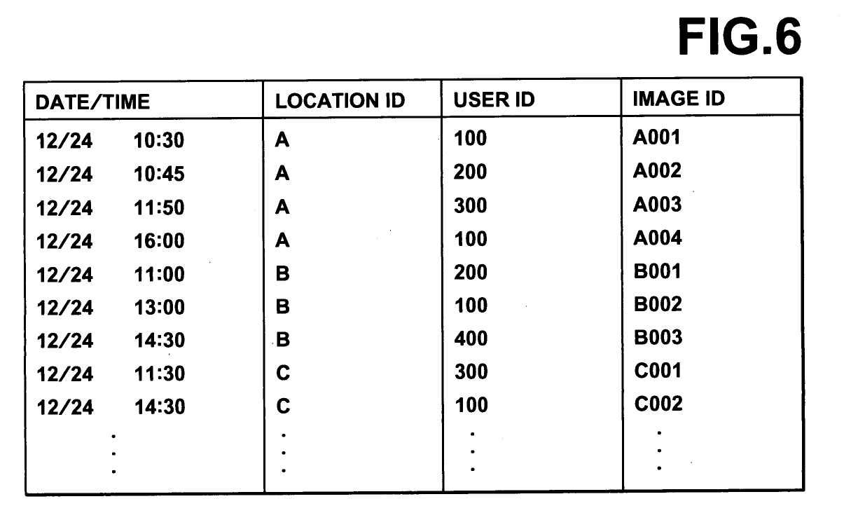

Note that individual location ID's are set for each of the photography units 10, according to the locations at which they are provided. Individual image ID's are attached to each of the image data sets, which are obtained by photography with the digital cameras 11. The transmitting means 12 groups the times/dates of photography, the location ID's, the image ID's of the image data sets obtained by photography, and the user ID's (subject specifying data) received from the wireless tags 21 during photography of the image data sets, as photography data. The transmitting means 12 transmits the image data sets, along with the photography data, to the server 30. The transmitted photography data are recorded in a photography data database, as shown in FIG. 6, within the server 30. The image data sets are similarly recorded within an image database within the server 30.

The server 30 comprises: a communication control portion 32; a recording portion 34; an image search portion 33; an image synthesis portion 35; and a CPU/memory 31. The communication control portion 32 communicates with the transmitting means 12 of the photography unit 10, the order terminals 40, and the output means 50. The recording portion 34 records therein the subject specifying data database, the image database, the photography data database, the template database, and the like. The image search portion 33 searches for predetermined image data sets, from within the image database. The image synthesis portion synthesizes image data sets with template data sets. The CPU/memory 31 controls the operations of the constituent portions of the server 30.

Each of the order terminals 40 comprises: a communication control portion 42; a monitor 43; an operating portion 44; an antenna 23; and a CPU/memory 41. The communication control portion 42 communicates with the server 30. The monitor 43 displays an order input screen and the like. The operating portion 44 is provided for the user to perform ordering operations. The antenna 23 receives subject specifying data from the wireless tags 21. The CPU/memory 41 controls the operations of the constituent portions of the server 30.

The output means 50 comprises: a printer; a recording device; a communication device and the like. The printer is for printing synthesized images on paper. The recording device is for recording the synthesized images in recording media. The communication device is for distributing the synthesized images on the Internet.

Next, the operations of the system for providing synthesized images 1 will be described.

First, a wireless tag 21 is provided to a user of the service (hereinafter, referred to as “subject P”). At this time, user information necessary for the service, such as the user's name, the user's address, and the user's telephone number are obtained. Then, the user information is correlated with the user ID of the wireless tag 21 and recorded in a subject specifying data database. Note that in the description of the present embodiment, the user ID of the wireless tag 21 provided to the subject P is designated as 100.

When the subject P who is holding the wireless tag 21 enters attractions, which are provided with photography units 10, and arrives at predetermined photography spots, the subject P is photographed by digital cameras 11. At this time, the subject specifying data (user ID) of the wireless tag 21, held by the subject P, is obtained. Transmitting means 12 transmit image data sets, which have been obtained by photography along with photography data, which includes the user ID obtained from the wireless tag 21, to the server 30.

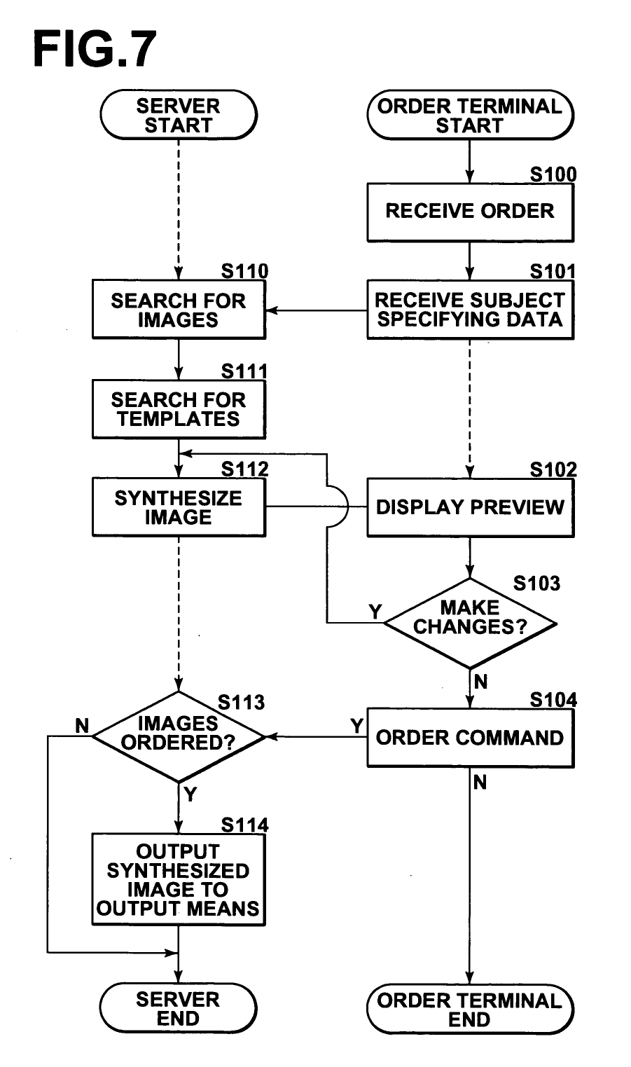

Next, the processes of image ordering and image synthesis will be described, with reference to the flow chart of FIG. 7.

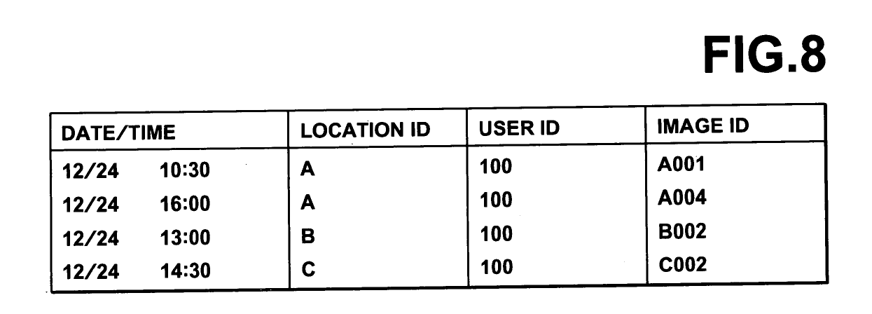

When the user (subject P) accesses an order terminal 40, the order terminal initiates order reception (step S101) At this time, the subject specifying data (user ID) of the user (subject P) is obtained from the wire less tag 21, and the user ID is transmitted to the server 30 (step S101) The server 30 extracts photography data corresponding to the user ID, based on the user ID received from the order terminal 40. Then, the server 30 searches for image data sets, in which the user is pictured, in the image database, based on the photography data (step S110). In the present embodiment, the photography data is extracted in the form shown in FIG. 8.

In addition, template data sets are searched for in the template database, based on the location ID's, which are included in the photography data, the number of photographed images, and the like, in the template database (step S111). Synthesized image data sets G are generated, by synthesizing the located template data sets and the image data sets with predetermined layouts, and the synthesized image data sets are transmitted to the order terminal 40 (step S112).

The order terminal 40 displays the synthesized image data set G, which have been received from the server 30, as preview images (step S102).

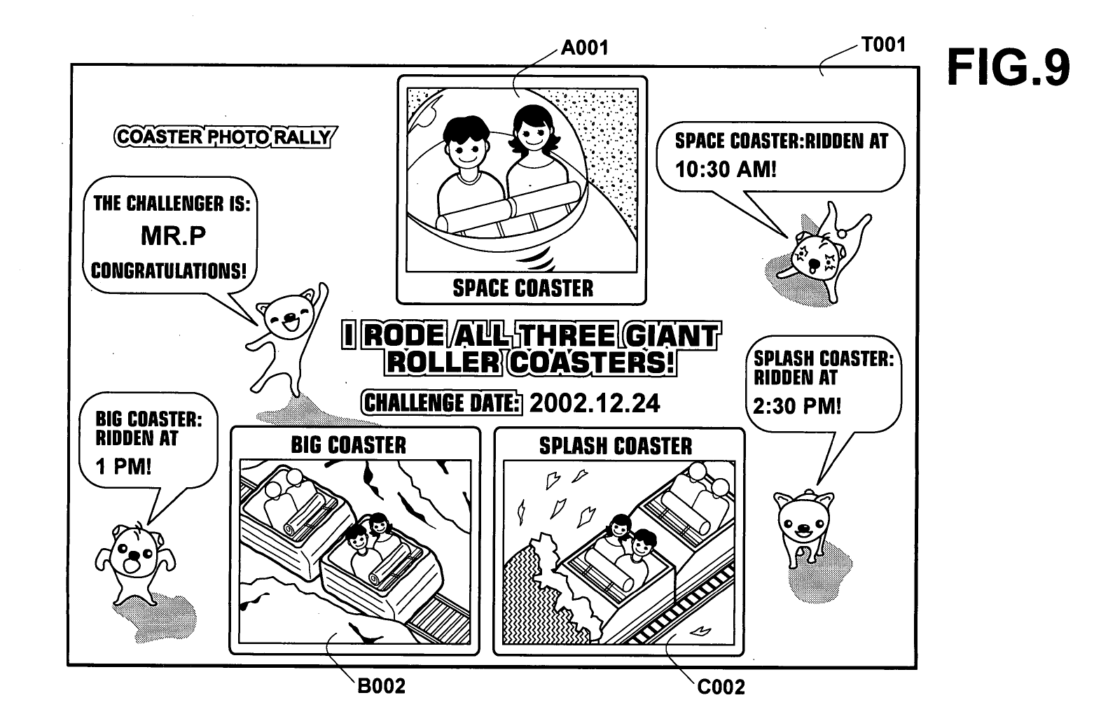

An example of the synthesized image data set G is shown in FIG. 9. Template data set T001 is provided with a region for synthesizing an image data set photographed at location A, a region for synthesizing an image data sets photographed at location B, and a region for synthesizing an image data set photographed at location C. Image data sets A001, B002, and C002, which have been photographed at locations A, B, and C, respectively, are synthesized into the template data set T001 at these regions. In addition, it is also possible to synthesize text data, such as the user's name and the times of photography for each image, based on the photography data and the user information.

Note that in the case that multiple images have been photographed at a single location, a predetermined image, such as the image which was photographed first, may be synthesized. Alternatively, the user may be notified that a plurality of images have been photographed, then prompted to select from among the plurality of images.

In addition, the template data set, with which the photographed images are synthesized, may be selected from among a plurality of template data sets, according to the number of photographed images.

Further, the image size to be output may be changed according to the number of photographed images. For example, the synthesized image data set may be output as a long print.

In the case that changes are to be made to the synthesized image data set G, which has been displayed as a preview image, the user is prompted to input the changes, and the input data s transmitted to the server 30 (step S103) Then, the steps from step S112 are repeated. In the case that there are no changes (step S103), the user is prompted to input an order, including the number of ordered images, the output mode, and the like. The order is transmitted to the server 30 (step S104).

The server 30 judges whether the synthesized image data set G has been ordered, based on the order received from the order terminal 40 (step S113). In the case that there is no order, the process ends. In the case that the synthesized image data set G has been ordered, the synthesized image data set G is output to the output means 50 (step S114), then the process ends.

By adopting a configuration such as that described above, images, which have been photographed at a plurality of locations within a tourist spot, are synthesized according to the photography locations of the images. Synthesized images, which are synthesized in favorable layouts, are provided. Accordingly, a more attractive service may be provided, compared to conventional image printing services.

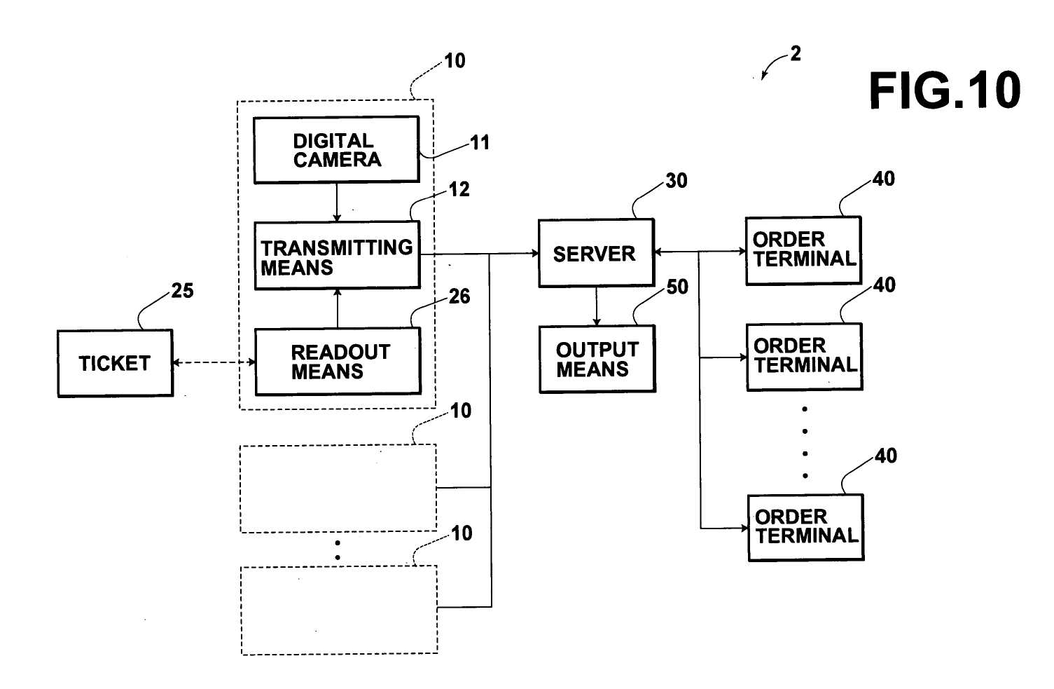

Next, a second embodiment of the present invention will be described. A system for providing synthesized images 2 according to the second embodiment differs from the system for providing synthesized images 1 of the first embodiment in that the obtainment method of the subject specifying data is changed. FIG. 10 is a block diagram illustrating the construction of the system for providing synthesized images 2. Note that elements in common with the first embodiment are denoted by the same reference numerals, and detailed descriptions thereof are omitted, unless necessary.

The system for providing synthesized images 2 comprises: a plurality of photography units 10; a plurality of tickets 25; a server 30; order terminals 40; and an output means 50. The photography units 10 perform automatic photography of subjects (users of the service). The tickets 25 are held by the subjects, and have subject specifying data that specifies the subjects. The server 30 stores image data sets obtained by the photography units 10, and generates synthesized images based on these image data sets. The order terminals 40 access the server 30 to order synthesized images. The output means 50 output the synthesized images, which are generated by the server 30.

As specific examples of the tickets 25, admission tickets for a theme park having individualized bar code patterns printed thereon, may be considered. The tickets 25 are distributed among users of the service provided by the system for providing synthesized images 2. In addition, at the time that the wireless tags 21 are distributed, user information necessary for the service, such as the user's name, the user's address, and the user's telephone number are obtained. Then, the user information is correlated with the individualized bar codes and recorded in a subject specifying data database within the server 30. Thereby, the tickets 25 need only to have the bar codes printed thereon as the subject specifying data.

Note that magnetic stripes, having individualized data recorded therein, may be provided instead of the bar codes.

Each of the photography units 10 comprises: a digital camera 11; a readout means 26; and a transmitting means 12. The digital camera 11 photographs the subjects. The readout means 26 reads out the subject specifying data from the tickets 25. The transmitting means 12 transmits the image data sets obtained by the digital camera 11 and the subject specifying data read out by the readout means 26 to the server 30.

Note that individual location ID's are set for each of the photography units 10, according to the locations at which they are provided. Individual image ID's are attached to each of the image data sets, which are obtained by photography with the digital cameras 11. The transmitting means 12 groups the times/dates of photography, the location ID's, the image ID's of the image data sets obtained by photography, and the bar codes (subject specifying data) read out from the tickets 25 during photography of the image data sets, as photography data. The transmitting means 12 transmits the image data sets, along with the photography data, to the server 30. The transmitted photography data are recorded in a photography data database within the server 30. The image data sets are similarly recorded within an image database within the server 30.

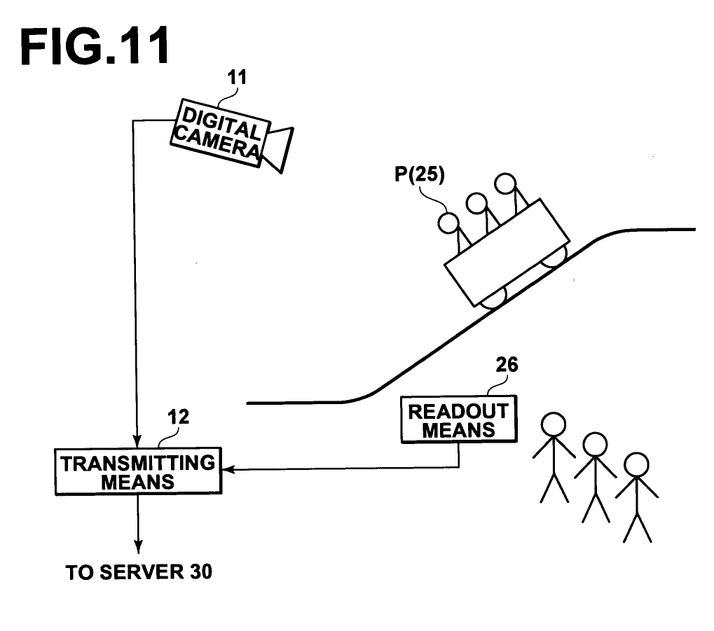

FIG. 11 illustrates an example, in which the photography unit 10 is provided at an attraction (a roller coaster) within a theme park. The digital camera 11 is provided at a position so that it is capable of performing photography when the roller coaster arrives at a predetermined photography spot. The readout means 26 is provided in the vicinity of the entrance to the attraction, and is configured to correlate a car that a user rides with a ticket 25 which is read out. Specifically, subject specifying data (bar code) is read out from the ticket 25 held by the user, in the vicinity of the entrance of the attraction. When the car of the roller coaster, which the user (subject P) is riding in, arrives at the predetermined photography spot, the digital camera 11 photographs the roller coaster (subject P). The transmitting means 12 transmits image data sets, which have been obtained by photography along with photography data, which includes the bar code read out from the ticket 25, to the server 30.

Note that the readout means 26 may be provided within each car within the attraction, or at each seat of each car.

In addition, the order terminals 40 are also provided with readout means 27, for reading out the bar codes from the tickets 25.

Effects similar to those of the first embodiment are obtainable from the configuration described above as well.

What is claimed is:

1. A system for providing synthesized images, comprising:
a plurality of cameras for photographing subjects and obtaining image data sets, provided at predetermined locations;
a transmitting means for transmitting the image data sets, provided at each of the plurality of cameras;
an image managing means for storing the image data sets, which have been transmitted by the transmitting means;
a subject specifying means, for specifying the subjects which are pictured in the image data sets;
a template managing means for storing template data sets, which are to be synthesized with the image data sets;
an image searching means for searching among the image data sets, which are stored in the image managing means, for image data sets, in which the subjects specified by the subject specifying means are pictured;
an image synthesizing means for generating synthesized image data sets, by synthesizing image data sets, which have been located by the image searching means, with predetermined template data sets from among the template data sets, which are stored in the template managing means, according to the photography location of the image data sets, in a predetermined layout; and
an output means, for outputting the synthesized image data sets.

2. A system for providing synthesized images as defined in claim 1, wherein the subject specifying means comprises:
subject specifying data transmitting means for transmitting prerecorded subject specifying data; and
subject specifying data receiving means for receiving the subject specifying data, transmitted from the subject specifying data transmitting means; wherein:
the subject specifying data transmitting means are distributed among subjects in advance; and
the subject specifying data receiving means receives the subject specifying data of a photographed subject from the subject specifying data transmitting means held by the photographed subject, corresponding to photography operations of the cameras.

3. A system for providing synthesized images as defined in claim 1, wherein the subject specifying means comprises:
media, in which subject specifying data are recorded; and
readout means for reading out the subject specifying data from the media; wherein:
the media are distributed among subjects in advance; and
the readout means reads out the subject specifying data of a photographed subject from the medium held by the photographed subject, corresponding to photography operations of the cameras.

4. A system for providing synthesized images as defined in claim 1, further comprising:
an image selecting means for selecting image data sets from among the image data sets, which have been located by the image searching means, to be synthesized with the template data sets.

5. A system for providing synthesized images as defined in claim 2, further comprising:
an image selecting means for selecting image data sets from among the image data sets, which have been located by the image searching means, to be synthesized with the template data sets.

6. A system for providing synthesized images as defined in claim 3, further comprising:
an image selecting means for selecting image data sets from among the image data sets, which have been located by the image searching means, to be synthesized with the template data sets.

7. A system for providing synthesized images as defined in claim 1, wherein the image synthesizing means comprises:
a template selecting means for selecting template data sets from among the template data sets, which are stored in the template managing means, to be synthesized with the image data sets; wherein:
the selected template data sets are synthesized with the image data sets.

8. A system for providing synthesized images as defined in claim 2, wherein the image synthesizing means comprises:
a template selecting means for selecting template data sets from among the template data sets, which are stored in the template managing means, to be synthesized with the image data sets; wherein:
the selected template data sets are synthesized with the image data sets.

9. A system for providing synthesized images as defined in claim 3, wherein the image synthesizing means comprises:
a template selecting means for selecting template data sets from among the template data sets, which are stored in the template managing means, to be synthesized with the image data sets; wherein:
the selected template data sets are synthesized with the image data sets.

10. A system for providing synthesized images as defined in claim 4, wherein the image synthesizing means comprises:
a template selecting means for selecting template data sets from among the template data sets, which are stored in the template managing means, to be synthesized with the image data sets; wherein:
the selected template data sets are synthesized with the image data sets.

11. A system for providing synthesized images as defined in claim 5, wherein the image synthesizing means comprises:
a template selecting means for selecting template data sets from among the template data sets, which are stored in the template managing means, to be synthesized with the image data sets; wherein:
the selected template data sets are synthesized with the image data sets.

12. A system for providing synthesized images as defined in claim 6, wherein the image synthesizing means comprises:
a template selecting means for selecting template data sets from among the template data sets, which are stored in the template managing means, to be synthesized with the image data sets; wherein:
the selected template data sets are synthesized with the image data sets.

13. A system for providing synthesized images as defined in claim 7, wherein:
the template selecting means increases the number of selectable template data sets, with which the image data sets are synthesized, according to the number of image data sets in which the same subject is pictured.

14. A system for providing synthesized images as defined in claim 8, wherein:
the template selecting means increases the number of selectable template data sets, with which the image data sets are synthesized, according to the number of image data sets in which the same subject is pictured.

15. A system for providing synthesized images as defined in claim 9, wherein:
the template selecting means increases the number of selectable template data sets, with which the image data sets are synthesized, according to the number of image data sets in which the same subject is pictured.

16. A system for providing synthesized images as defined in claim 10, wherein:
the template selecting means increases the number of selectable template data sets, with which the image data sets are synthesized, according to the number of image data sets in which the same subject is pictured.

17. A system for providing synthesized images as defined in claim 11, wherein:
the template selecting means increases the number of selectable template data sets, with which the image data sets are synthesized, according to the number of image data sets in which the same subject is pictured.

18. A system for providing synthesized images as defined in claim 12, wherein:
the template selecting means increases the number of selectable template data sets, with which the image data sets are synthesized, according to the number of image data sets in which the same subject is pictured.

19. An image synthesizing apparatus comprising:
an image receiving means for receiving input of image data sets; and
an image synthesizing means; wherein
the image synthesizing means generates synthesized image data sets, by synthesizing image data sets, which have been input, with predetermined template data sets according to the photography location of the image data sets, in a predetermined layout.

20. A program that causes a computer to execute a method for synthesizing images, comprising the procedures of:
receiving input of image data sets; and
generating synthesized images; wherein
synthesized images are generated, by synthesized image data sets, which have been input, with predetermined template data sets according to the photography location of the image data sets, in a predetermined layout.

21. A computer readable medium having stored therein the program defined in claim 20.
